(19) United States
(12) Patent Application Publication
(10) Pub. No.: US 2002/0121151 A1
(43) Pub. Date: Sep. 5, 2002

(54) Drive system for an adjustable vehicle part

(76) Inventors: Thomas Kraus, Gauting (DE); Rudolf Engl, Wald Kraiburg (DE); Joachim Klesing, Munchen (DE); Bernhard Meier, Kirchheim (DE)

Correspondence Address: NIXON PEABODY, LLP, 8180 GREENSBORO DRIVE, SUITE 800, MCLEAN, VA, 22102, US

(21) Appl. No.: 09/926,747

(22) PCT Filed: Mar. 29, 2001
(86) PCT No.: PCT/EP01/03606

(30) Foreign Application Priority Data
Apr. 12, 2000 (DE) 100 18 230.5

(51) Int. Cl. F16H 1/16; F16H 1/20

(52) U.S. Cl. 74/425

(57) ABSTRACT

The invention relates to a drive for an adjustable motor vehicle part which has an electric motor (10), a worm drive which has a worm wheel (28) surrounded by a gearbox (36, 38; 136, 148), and electronic components (32, 34) for operation of the electric motor. At least the important part of the electronic components (32, 34) is located between the worm wheel (28) and the gearbox (38; 138).

This invention relates to a drive for an adjustable motor vehicle part, especially a cover element of a motor vehicle roof, as claimed in the preamble of claim 1.

DE 43, 37, 390 A1 discloses a generic drive in which the brush box for the electric motor is connected to the electronics housing which is made separately from the gearbox which surrounds the worm wheel and is clipped onto it, the brush holder support being located near the worm shaft. The electronics housing is offset laterally with respect to the worm wheel and surrounds the electronic components of the motor electronics which also comprises shielding components, and the electronic components can be located on a card accommodated in the electronics housing or can be contained in an integrated component. The motor electronics can consist of a potted component which has the electronic components. Flow takes place through the brushes which are supported to be able to move lengthwise in the brush box via metal paths which are not a component of the motor electronics boards.

DE 43, 15, 404 A1 discloses a drive in which a brush holder which is located within the motor housing is used as a carrier for a circuit board which has the power and control electronics for the motor.

DE 90, 13, 006 U1 discloses a generic drive in which the components of the motor electronics are located on a circuit board laterally offset with respect to the worm wheel within the gearbox. The circuit board is also used as a holder for a brush holder support which is located near the worm wheel or the worm shaft. The electronic components can be made as SMD components.

Another generic drive is known from EP 0, 538, 495 A1 in which the brush holder support is made as a separate component as a plate and is connected by a plug to the motor electronics accommodated in a separate electronics housing which can be plugged onto the gearbox.

DE 43, 23, 946 C1 discloses another generic drive in which the worm wheel and the motor electronics are accommodated in separate housing parts which are detachably connected to one another.

The relatively large amount of space required is a disadvantage in these drives.

The object of this invention is to devise a drive for an adjustable motor vehicle part which is made as compact as possible.

This object is achieved as claimed in the invention by a drive as is defined in claim 1. In this way the space requirement of the drive can be reduced overall by the motor electronics, instead of its being located as in the past next to the worm wheel, being shifted into the area of the worm wheel and thus installation space being saved.

In one advantageous embodiment the electronic components are located essentially within the contour of the worm wheel and can be formed at least in part by ASICs and/or can be made as SMD components.

The electronic components can be mounted on a card which is parallel to the worm wheel, or they can be mounted directly on the gearbox.

The brush system can be integrated into the gearbox or into the card, and in the former case the gearbox can be provided with a receiver for the brush holder support and a contact-making means for the brush holder support which can be inserted and/or extrusion-coated conductive elements.

Embodiments of the invention are detailed below using the attached drawings.

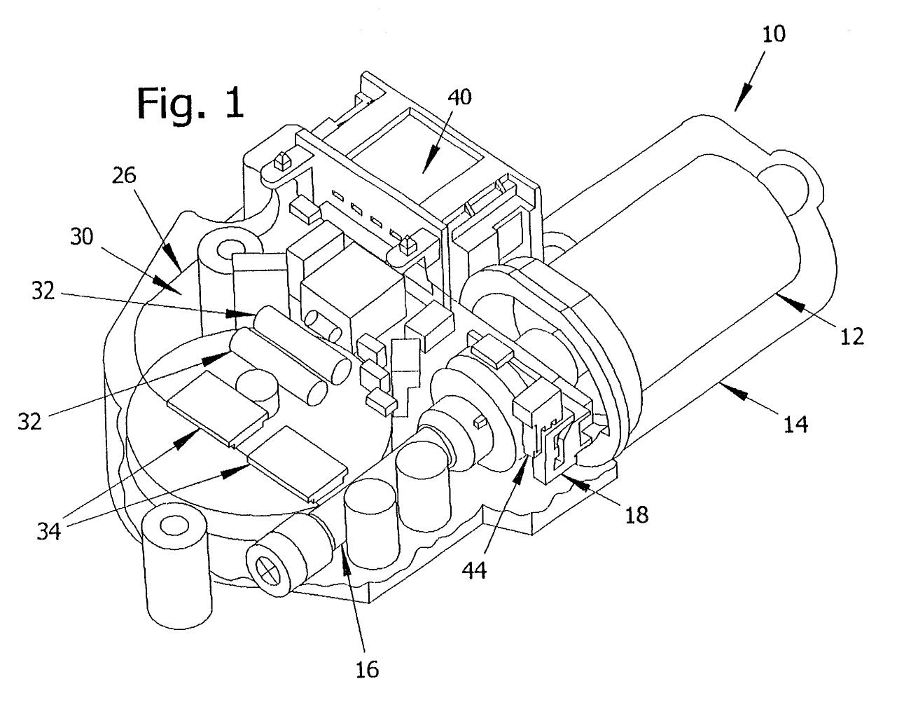

FIG. 1 shows a perspective view of a first embodiment of the invention in the installed state;

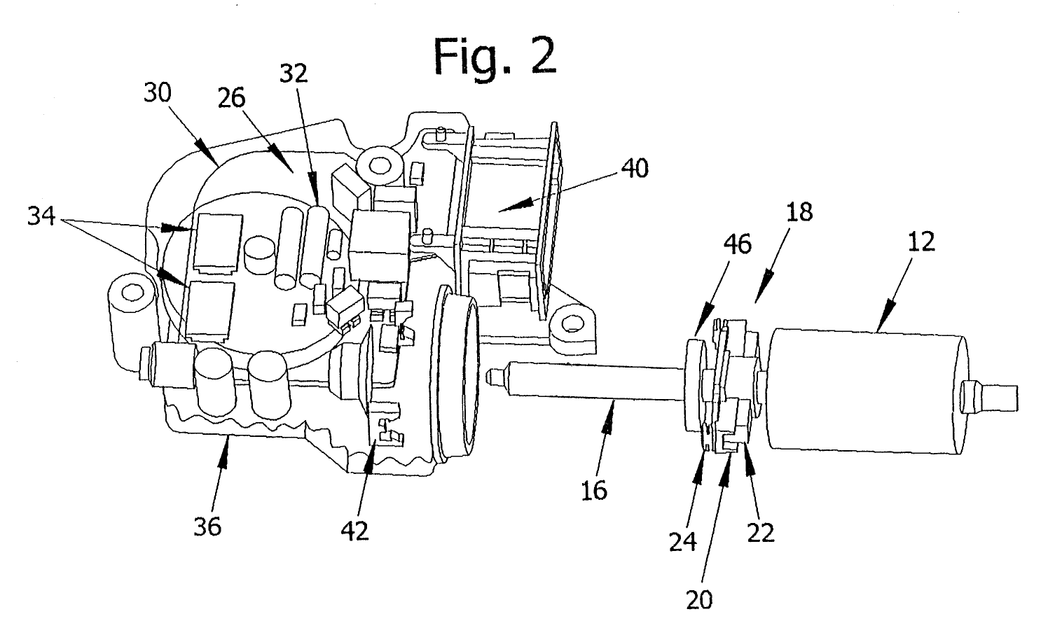

FIG. 2 shows the embodiment from FIG. 1 in installation;

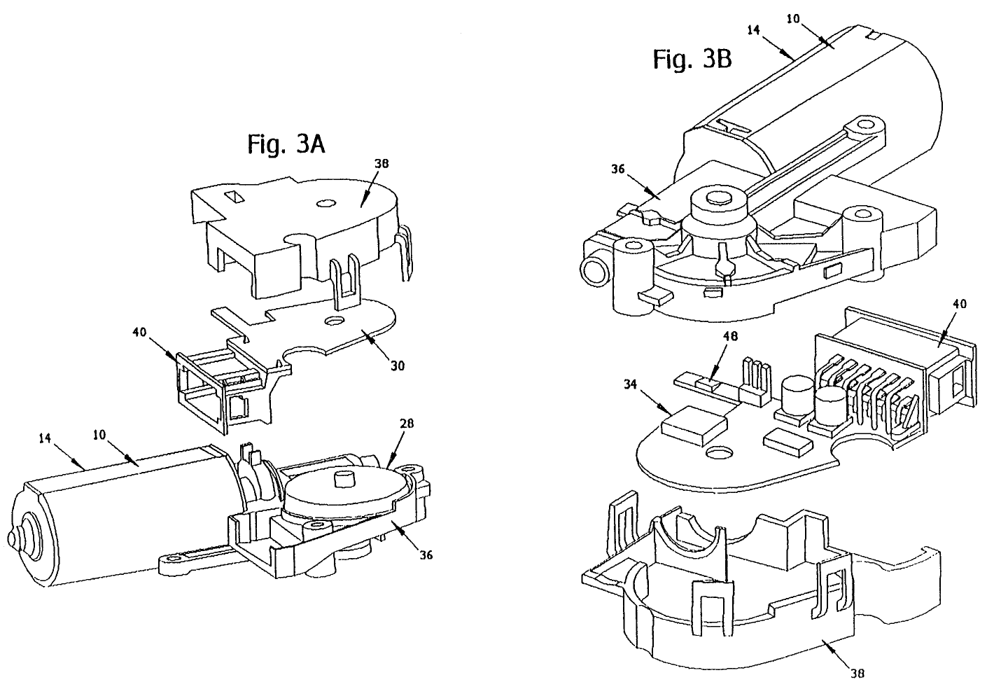

FIGS. 3A and 3B show perspective representations from different viewing angles which likewise illustrate the installation of the embodiment from FIGS. 1 and 2; and

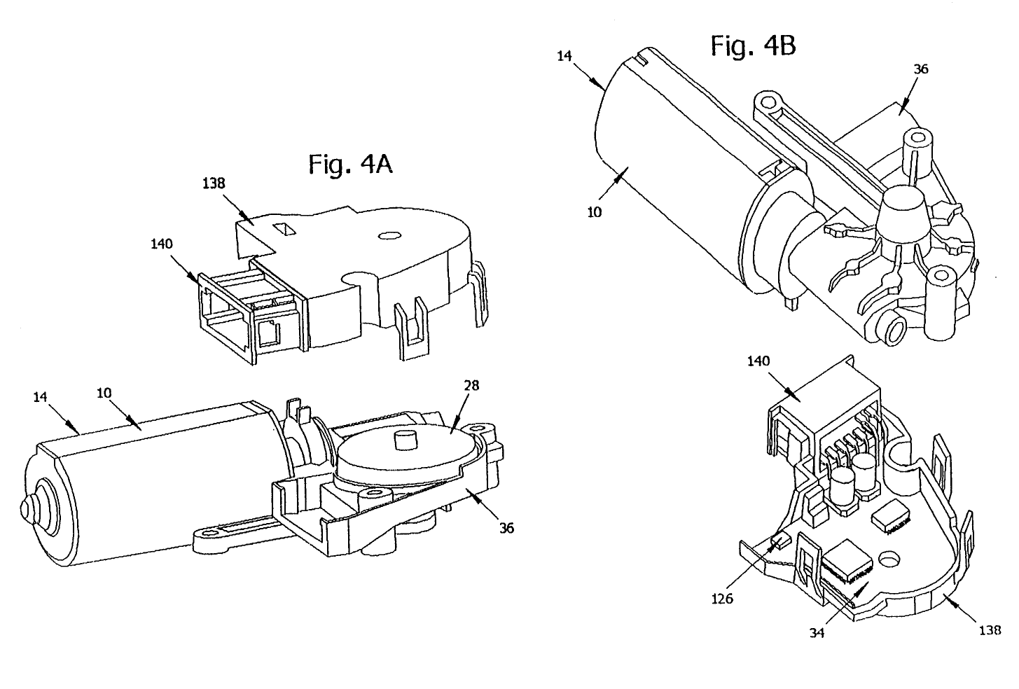

FIGS. 4A and 4B show views similar to FIG. 3A and 3B, however a second embodiment of the invention being shown.

A first embodiment of the invention is shown in FIGS. 1 to 3B, the drive unit comprising an electric motor 10 with an armature 12 which is surrounded by a pole pot 14, a motor shaft or a pole shaft 16 and a brush system 18 which has a brush holder support 20 for holding the brushes 22 and contact-making 24 for electrical contact with the motor electronics 26. The motor shaft 16 in its front area bears a worm shaft (not shown) which engages a worm wheel 28. The term “bears” here is intended to encompass a worm shaft which is made as a separate component and also a worm shaft which is made in one piece with the motor shaft 16. The step-down gearing formed in this way is used to drive an adjustable motor vehicle part, its preferably being the cover element of an openable motor vehicle roof, for example the cover of a sliding roof or sliding and lifting roof or the louver of a louvered roof.

The motor electronics 26 are housed on a circuit board or card 30 which is located parallel and essentially concentrically to the worm wheel 28. The motor electronics 26 comprises the control electronics for the motor 10, and EMC shielding elements 32 for the motor 10. The components of the motor control are made preferably at least in part as ASICs 34. All electronic components are made preferably as SMD components.

The gearbox consists preferably of plastic and is formed by a carrier part 36 and a box cover 38. The carrier part 36 bears the electric motor 10 and the worm wheel 28, while the circuit board 30 with the motor electronics 26 is located between the worm wheel 28 and the box cover 38. The circuit board 30 furthermore bears an electrical plug-in connection 40 for connection of the power supply and control lines. The carrier part 36 is provided with a receiver 42 for the brush holder support 20 and with a corresponding contact-making means 44 which is an inserted or extrusion-coated conductive element so that the brush system is integrated into the gearbox. The contact-making means 44 can be integrated into the card 30 or can be connected to it via separate printed conductors. Alternatively the brush holder support can be integrated into the card 30. In this case there must be a ground connection between the card 30 and the pole pot 14.

The motor shaft 16 is provided torsionally strong with a magnet wheel 46 which interacts with Hall sensors 48 provided on the card 30 in order to detect the position of the adjustable motor vehicle part which is driven by the drive unit.

The combination of electronic functions in the form of ASICs 34 reduces the number of required electronic components and thus reduces the required installation space and production costs. Making the electronic components as SMD components likewise results in miniaturization and cost reduction.

A still more compact form of the drive unit is shown in FIGS. 4A and 4B; it differs essentially from the embodiment described so far in that there is no separate card 30 for the motor electronics 26, but that the components of the motor electronics 126 are mounted directly on the inside of the box cover 138 in the area above the worm wheel 28. Here it is essential that the gearbox or at least the cover 138 is made of electrically insulating material, preferably plastic, the printed conductors being applied to the inside of the box cover 138 for electrically connecting the electronic components. The electronic components are made preferably as SMD components. This type of electronics execution is also known as MID (Molded Interconnected Device). The plug-in connection 140 is made as part of the box cover 138.

The embodiment as shown in FIGS. 4A and 4B allows a more compact execution of the drive unit by eliminating the card.

In the described embodiments it is essential that the electronic components of the motor electronics are located essentially between the worm wheel and the gearbox, preferably essentially within the contour of the worm wheel.

1. Drive for an adjustable motor vehicle part, with an electric motor (10) with a worm drive which has a worm wheel (28) surrounded by a gearbox (36, 38; 136, 148), and with electronic components (32, 34) for operation of the electric motor, characterized in that at least the important part of the electronic components (32, 34) is located between the worm wheel (28) and the gearbox (38; 138).

2. Drive as claimed in claim 1, wherein the electronic components (32, 34) are located essentially within the contour of the worm wheel (28).

3. Drive as claimed in claim 1 or 2, wherein the electronic components are formed at least in part by ASICs (34).

4. Drive as claimed in one of the preceding claims, wherein the electronic components (32, 34) are formed as SMD components.

5. Drive as claimed in one of the preceding claims, wherein the gearbox consists essentially of a carrier (36; 136) which bears the electric motor (10) and the worm wheel (28), and a box cover (38; 138).

6. Drive as claimed in one of the preceding claims, wherein the electronic components (32, 34) are mounted directly on the gearbox (138).

7. Drive as claimed in claim 5, wherein the electronic components (32, 34) are mounted directly on the box cover (138).

8. Drive as claimed in claim 7, wherein the box cover (138) is made of electrically insulating material.

9. Drive as claimed in claim 8, wherein the box cover (138) is made of plastic to which printed conductors are applied for electrical connection of the electronic components (32, 34):

10. Drive as claimed in claim 5, wherein the box cover (138) is provided with an electrical terminal (140).

11. Drive as claimed in claim 1 to 5, wherein the electronic components (32, 34) are mounted on a card (30) which is parallel to the worm wheel (28).

12. Drive as claimed in claim 11, wherein the card (30) lies between the box cover (38) and the worm wheel (28).

13. Drive as claimed in one of the preceding claims, wherein the motor shaft (16) bears a worm which engages a worm wheel (28), and the brush system (18) for the electric motor (10) is located in the vicinity of the worm.

14. Drive as claimed in claim 13, in so far as referenced to claim 6 or 7, wherein the brush system (18) is integrated into the gearbox (36; 136).

15. Drive as claimed in claim 14, wherein the gearbox (36; 136) is provided with a receiver (42) for the brush holder support (20).

16. Drive as claimed in claim 15, wherein the gearbox (36; 136) is provided with contact-making means (44) for the brush holder support (20).

17. Drive as claimed in claim 16, wherein the contact making means (44) is inserted and/or extrusion-coated conducting components.

18. Drive as claimed in claim 13, in as much as referenced to claim 11, wherein the brush system is integrated into the card.
